(19) United States
(12) Patent Application Publication
(10) Pub. No.: US 2026/0342910 A1
(43) Pub. Date: Oct. 29, 2026

(54) MIGRATION BETWEEN TELEPHONY COMMUNICATION SYSTEMS

(71) Applicant: G.S. CONSULTING & RESEARCH CORRENET LTD, Nes Ziona (IL)

(72) Inventor: Oran Moshe, Mashen (IL)

(21) Appl. No.: 19/191,423

(22) Filed: Apr. 28, 2025

(51) Int. Cl. H04M 3/42

(52) U.S. Cl. CPC H04M 3/42136; H04M 3/4228

(57) ABSTRACT

A method, apparatus and computer program product for migrating a source to target telephony systems, the method comprising: obtaining from the source entities comprising first and second entities, the first entity comprises first and second fields, the first field having a primitive value, the second field having a reference value referring the second entity; before the second entity is added: generating a new first entity, comprising first and second new fields corresponding to the first and second fields in the first entity, the new first field assigned the primitive value, the new second field not assigned a value; and adding the new first entity to the target; generating a new second entity corresponding to the second entity; adding the new second entity to the target; and updating the new first entity, comprising assigning a new reference value referring the second new entity within the target to the second new field.

### TECHNICAL FIELD

The disclosure generally relates to the field of providing communication services, and specifically to migrating entities in a telephony system of an organization from a source telephony system to a target telephony system.

### BACKGROUND

A communication system, including a telephony system is one of the most significant backbones of many organizations, such as commercial companies, educational institutes, banks, government offices, NGOs, or others.

A communication system, including a telephony system is one of the most significant backbones of many organizations, such as commercial companies, educational institutes, banks, government offices, NGOs, or others. In the last decades, a significant part of the communication volume is carried out using Voice over Internet Protocol (VOIP).

A significant part of the organizations use communication networks comprising one or more telephony systems, whether on-premise private exchange branches (PBXs) or VoIP systems, or modern cloud-based networks which suggest significant advantages they offer.

Telephony systems may support one or more entities, including users, lines, devices and additional entities, such as hunt groups, shared lines, or the like.

Each entity may be represented in the telephony system as a record, object or another data structure comprising one or more primitive fields which contain a literal value such as a number of any type, a character, a string, an enumerated value, or the like.

Entities may also comprise complex fields which point at or comprise an identifier of another entity or a plurality of entities, whether ordered or not.

Multiple organizations, and in particular larger ones, upgrade their communication network at times, by replacing an existing telephony system with another one, which is usually more advanced, supports more entities, by adding additional telephony systems to their communication networks, or the like.

In such cases, multiple entities should be transferred from the existing telephony system, also termed the source telephony system, to the new telephony system, also termed the target telephony system.

### BRIEF SUMMARY

One exemplary embodiment of the disclosed subject matter is a method for migrating a plurality of entities from a source telephony system to a target telephony system, the method comprising: obtaining from the source telephony system the plurality of entities, the plurality of entities comprises a first entity and a second entity, wherein the first entity comprises at least a first field and a second field, wherein the first field of the first entity has a primitive value, wherein the second field of the first entity has a reference value referring to the second entity; prior to the second entity being added to the target telephony system: generating a new first entity corresponding to the first entity, wherein the new first entity comprising a first new field and a second new field, the first new field and the second new field correspond to the first field and the second field in the first entity, respectively, wherein the new first field is assigned the primitive value, wherein the new second field is not assigned a valid reference value; and adding the new first entity to the target telephony system; after the new first entity was added to the target telephony system: generating a new second entity corresponding to the second entity; adding the new second entity to the target telephony system; and after the new second entity was added to the target telephony system: updating the new first entity in the target telephony system, wherein said updating comprises assigning a new reference value referring to the second new entity within the target telephony system to the second new field. Within the method, the first entity is optionally of a first type and the second entity is optionally of a second type, the first and second types are optionally different. Within the method, said updating the new first entity is optionally performed after corresponding entities were added to the target telephony system for each entity of the second type in the plurality of entities. Within the method, said updating the new first entity is optionally performed after corresponding entities were added to the target telephony system for each entity in the plurality of entities. Within the method, said generating the new first entity optionally comprises for each source field in the first entity that has a primitive value and has a corresponding target field in the new first entity, assigning to the corresponding target first a corresponding primitive value. Within the method, said generating the new first entity optionally comprises assigning in the new first entity all primitive values of the first entity. Within the method, the first entity is optionally an entity representing a user, wherein the second entity is optionally an entity representing a telephone device, whereby the first entity optionally refers to the second entity to indicate that the telephone device is used by the user. Within the method, the first entity is optionally a hunt group entity representing a group of phone lines, wherein the second entity optionally represents a phone line, whereby the first entity optionally refers to the second entity to indicate that the phone line is part of the hunt group of phone lines. Within the method, during addition of the first entity to the target telephony system, the first field is optionally assigned a temporary value indicating the second entity. Within the method, the source telephony system is optionally of a different version than the target telephony system. Within the method, adding the new entity or the new second entity to the target telephony system is optionally subject to application of a rule. Within the method, the first entity optionally represents a telephone device and the second entity represents a phone line. Within the method, the plurality of entities optionally comprises: at least one entity representing a telephone device, at least one entity representing a phone line, and at least one entity representing a user.

Another exemplary embodiment of the disclosed subject matter is a computerized apparatus having a processor, the processor being configured to perform: obtaining from the source telephony system the plurality of entities, the plurality of entities comprises a first entity and a second entity, wherein the first entity comprises at least a first field and a second field, wherein the first field of the first entity has a primitive value, wherein the second field of the first entity has a reference value referring to the second entity; prior to the second entity being added to the target telephony system: generating a new first entity corresponding to the first entity, wherein the new first entity comprising a first new field and a second new field, the first new field and the second new field correspond to the first field and the second field in the first entity, respectively, wherein the new first field is assigned the primitive value, wherein the new second field is not assigned a valid reference value; and adding the new first entity to the target telephony system; after the new first entity was added to the target telephony system: generating a new second entity corresponding to the second entity; adding the new second entity to the target telephony system; and after the new second entity was added to the target telephony system: updating the new first entity in the target telephony system, wherein said updating comprises assigning a new reference value referring to the second new entity within the target telephony system to the second new field. Within the apparatus, the first entity is optionally of a first type and the second entity is optionally of a second type, the first and second types are optionally different, and wherein said updating the new first entity is optionally performed after corresponding entities were added to the target telephony system for each entity of the second type in the plurality of entities. Within the apparatus, said updating the new first entity is optionally performed after corresponding entities were added to the target telephony system for each entity in the plurality of entities. Within the apparatus, said generating the new first entity optionally comprises for each source field in the first entity that has a primitive value and has a corresponding target field in the new first entity, assigning to the corresponding target first a corresponding primitive value. Within the apparatus, said generating the new first entity optionally comprises assigning in the new first entity all primitive values of the first entity. Within the apparatus, the first entity is an entity representing a user, wherein the second entity is an entity representing a telephone device, whereby the first entity refers to the second entity to indicate that the telephone device is used by the user.

Yet another exemplary embodiment of the disclosed subject matter is a computer program product comprising a non-transitory computer readable storage medium retaining program instructions, which program instructions when read by a processor, cause the processor to execute the instructions comprising: obtaining from the source telephony system the plurality of entities, the plurality of entities comprises a first entity and a second entity, wherein the first entity comprises at least a first field and a second field, wherein the first field of the first entity has a primitive value, wherein the second field of the first entity has a reference value referring to the second entity; prior to the second entity being added to the target telephony system: generating a new first entity corresponding to the first entity, wherein the new first entity comprising a first new field and a second new field, the first new field and the second new field correspond to the first field and the second field in the first entity, respectively, wherein the new first field is assigned the primitive value, wherein the new second field is not assigned a valid reference value; and adding the new first entity to the target telephony system; after the new first entity was added to the target telephony system: generating a new second entity corresponding to the second entity; adding the new second entity to the target telephony system; and after the new second entity was added to the target telephony system: updating the new first entity in the target telephony system, wherein said updating comprises assigning a new reference value referring to the second new entity within the target telephony system to the second new field.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 is a schematic illustration of an exemplary environment, such as a communication network of an organization, in accordance with some exemplary embodiments of the disclosure;

FIG. 2 is a flowchart of steps in a method for migrating entities from a source communication system to a target, in accordance with some exemplary embodiments of the disclosure; and

FIG. 3 shows a block diagram of a system for showing a flowchart of steps in a method for migrating entities from a source communication system to a target, in accordance with some exemplary embodiments of the disclosure, in accordance with some exemplary embodiments of the disclosure.

### DETAILED DESCRIPTION

In the disclosure below, the terms PBX, telephony system, telephone exchange system, and telephone communication system are used interchangeably.

A typical communication network in an organization comprises one or more telephone exchange systems, such as but not limited to a private branch exchange (PBX) systems. In addition, the network may comprise a management system, adapted to communicate with and coordinate the various telephone exchange systems for implementing the business logic of the organization, such as setting or changing a configuration, starting or stopping a PBX, backing up information, responding to requests issued by the telephone communication systems, or the like.

Organizations may adapt their resources, including their communication network, to their changing needs. Thus, an organization may replace one or more PBXs with more advanced or larger ones. Additionally or alternatively, an organization may add more PBXs to its communication system. In these scenarios, the organization may have to transfer one or more entities associated with a source telephone system to a target telephony system. The entities may include any one or more of the following: one or more users, one or more lines, and one or more devices such as phones. The entities may further include additional entities, such as hunt groups, shared lines, or the like.

The entities may be inter-related, such that one or more lines and/or one or more devices may be associated with a human user. In another example, multiple users may be associated with a line, such as n a hunt group, where incoming calls made to a single number are re-routed to multiple phone lines and distributed to a group of people, such that the call may reach any one of the people in the group. Thus, the hunt group entity represents a group of phone lines, such that the hunt group entity refers to a plurality of phone lines that are part of the hunt group of phone lines.

In yet another example, a line may be shared by two or more people, for example a person and one or more secretaries.

Each entity may be represented in the telephony system it is associated with as an abstract record or object having multiple fields. One or more fields may be “primitive” fields, containing literal values such as a number of any type, a character, a character string, an enumerated value, or the like. Other fields may represent interrelations between the entities, for example as a pointer to another entity or an identifier of another entity or a plurality of entities.

One technical problem handled by the disclosure relates to migrating or transferring a group of entities from a source telephony system to a target telephony system, wherein interrelations exist between entities in the group.

It is appreciated that if interrelations exist between entities in the group, the entities cannot simply be transferred one after the other, since in some cases a first entity having a field that points at a second entity is transferred before the second entity, and thus cannot refer to it. In some cases, the dependencies are both ways, such that a first entity depends on a second entity, and vice versa. In further cases, circles of three or more entities may exist, wherein a first entity depends on a second entity, the second entity depends on a third entity, and the third entity depends on the first entity.

One technical solution of the disclosure comprises obtaining from the source telephony system a plurality of entities that need to be transferred. These can be all the entities associated with the source telephony system or part thereof, according to a user's instructions. The entities may be provided as a set, a list or any other collection, may be written to a file, provided as a stream, or the like. The plurality of entities may include a first entity of a first type, and a second entity of a second type. Entities of the first type may have at least one first primitive field and at least one second field which refers to a second entity of the second type. In some embodiments, the first entity and second entity may be of different types, such as a device and a user, a user and a line, or the like.

Prior to the second entity being added to the target telephony system, a new first entity may be generated upon the first entity, wherein the new first entity may have a new first field corresponding to the first field of the first entity, and a new second field corresponding to the second field, which is not assigned any valid reference value. The new first field may be assigned a value corresponding to the value of the first field of the first entity. In some embodiments, fields in the new first entity may be generated which correspond to all primitive fields of the first entity, and may be assigned corresponding values. Corresponding values may refer to the same values if the types are the same, or to corresponding values that have been cast, for example from a character to a number, form an integer to a float, or the like. The new first entity may then be added to or registered with the target telephony system.

Then, after adding the new first entity, a new second entity may be generated which corresponds to the second entity. One or more primitive fields of the new second entity may be set according to the corresponding fields in the second entity.

The new second entity may then also be added to, or registered with the target telephony system.

Then once the new second entity is registered with the target telephony system, the second field of the new first entity may be assigned a value corresponding to the new second entity.

In some embodiments, the new first entity may be updated after new second entities have been generated and added to the target telephony system for all entities of the second type, or for all entities that are being transferred to the target telephony system.

One technical effect of the disclosure is the preservation of the interrelations between the first entity and the second entity in the source telephony system, which is maintained between the new first entity and the new second entity.

Another technical effect of the disclosure is the ease of implementation of the transfer. By first generating new entities for all entities, with only the primitive fields being set, and then traversing through the elements to set the values of the fields that refer to other entities, it may be assured that all entities are transferred correctly. It is appreciated that although faster algorithms may be designed, such transfer is not an everyday job, so that a longer transfer time may be tolerated.

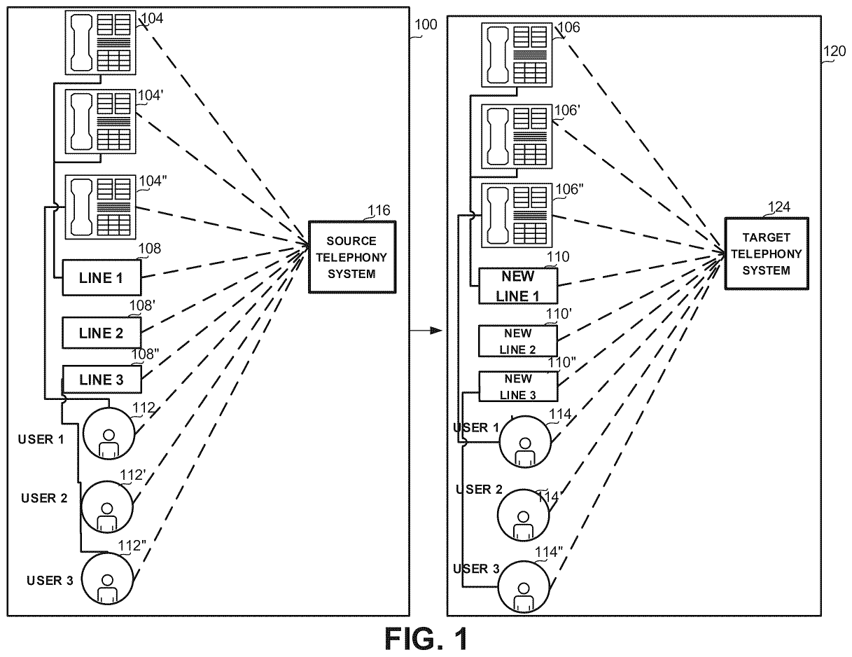

Referring now to FIG. 1, showing a schematic illustration of an exemplary environment, such as a communication network of an organization, comprising a source and target telephony communication systems, in accordance with some exemplary embodiments of the disclosure.

Source communication system 100 comprises a source telephony system 116, and a plurality of entities connected thereto. The entities may include, for example one or more telephone devices 104, 104′ or 104″, one or more telephone lines such as line 1 (108), line 2 (108′) and line 3 (108″), and one or more users such as user 1 (112), user 2 (112′) and user 3 (112″).

It is appreciated that the entity types are not limited to the displayed ones, and entities of other types may also be associated with the telephony system, such as hunt groups, user groups, application dial rules, credential policy, or others.

The entities may be interrelated. For example, telephone 104 and telephone 104′ may both be connected to line 1 (108), such as in a person and secretary configuration. In another example, telephone 104″ may be associated with user 1 (112). In yet another example, line 3 (108″) may be associated with user 3 (112″).

Target communication system 120 comprises a source telephony system 124, and has connected thereto a plurality of entities representing the same entities as in source communication system 100. Thus, the entities may include telephone devices 106, 106′ or 106″ corresponding to telephone devices 104, 104′ or 104″, telephone lines 110, 110′ and 110″ corresponding to lines 108, 108′ and 108, and users 114, 114′ and 114″, corresponding to users 112, 112′ and 112″.

The interrelations between the entities in communication system 120 are the same as the interrelationship in communication system 100.

It is appreciated that each entity may be represented in the respective telephone system as a record or object having a plurality of fields. Some of the fields, which may include a unique identifier for each entity, may be primitive, for example a number or string. Other fields may be complex, for example refer to another entity or to a collection or set of multiple entities, such as multiple telephone devices associated with one line, a hunt group associated with a plurality of lines or users, or the like.

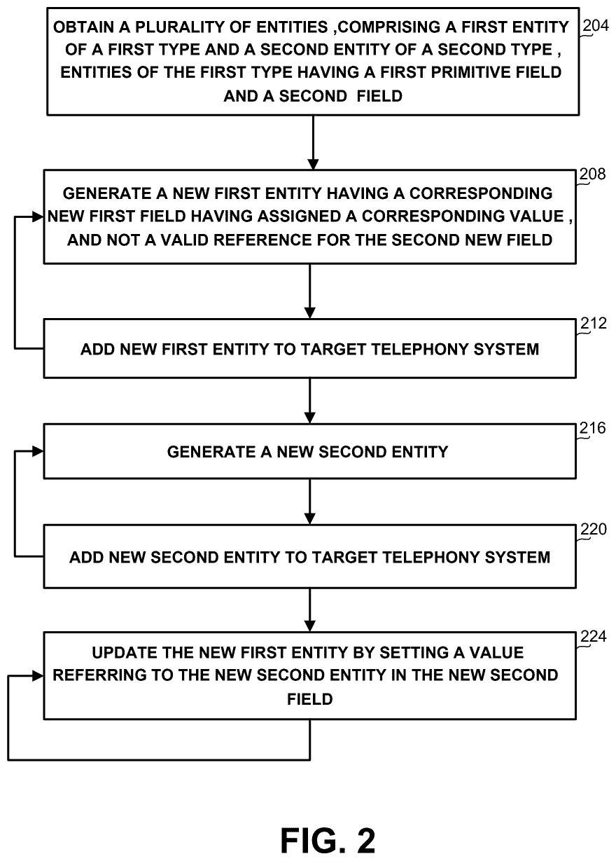

Referring now to FIG. 2, showing a flowchart of steps in a method for migrating entities from a source communication system to a target, in accordance with some exemplary embodiments of the disclosure.

The migration may be performed for all types of source communication system and target communication system, including but not limited to cases where the source telephony system is of a manufacture or version other than the target telephony system.

At step 204, a plurality of entities may be received, which are to be transferred from a source telephony system. The source telephony system may be a source PBX that is about to be replaced, or that some of its entities are to be transferred to another PBX. The plurality of entities may be received from the PBX or from another source, such as a management system, a file, a database, or the like.

In some exemplary embodiments, the plurality of entities may comprise one or more entities representing a telephone device, one or more entities representing a phone line, and one or more entities representing a user. It is appreciated that the plurality of entities may comprise entities of further types.

The list may thus comprise at least a first entity of a first type and a second entity of a second type, wherein the first type and the second type may be different. For example, the first entity may represent a telephone device and the second entity may represent a phone line. In another example, the first entity may represent a user and the second entity may represent a telephone device, wherein the first entity refers to the second entity to indicate that the telephone device is used by the user. In yet another example, the first entity may represent a hunt group being a group of phone lines and the second entity may represent a phone line, wherein the first entity refers to the second entity to indicate that the phone line is part of the hunt group of phone lines.

The first entity may comprise at least one primitive field, for example an identifier field, and a second field which may refer to one or more other entities.

At step 208, before the second entity is added to the target telephony system, a new first entity may be generated upon the first entity. The new first entity may have fields corresponding to the fields of the first entity. However, the fields of the new first entity may be of different type, such as a float number instead of an integer, a string instead of a character, or the like.

The new fields of primitive types may then be assigned values corresponding to the values of the corresponding fields in the first entity. If required, the value may be cast to the type of the field in the new first entity. In some exemplary embodiments, all primitive fields of the new first entity may be assigned the values of the corresponding primitives fields of the first entity.

The field in the new first entity corresponding to the second field in the first entity may not be assigned a valid value. For example, it may be left unassigned, assigned a default or temporary value indicating the second entity, or the like.

At step 212, the new first entity may be added to the target telephony system. Adding the new first entity to the target telephony system may be subject to the application of a rule.

In some exemplary rules, in some systems the default value of certain fields may be set. For example, “Srtpallowed” (Secure Real-time Transport Protocol), “EnableEmcc” (extension mobility cross cluster), “EnableCti” (computer telephony integration), “EnableMobile VoiceAccess” may be set to “false”; a default value for dateTimeSettingName =may be “CMLocal”.

Steps 208 and 212 may be repeated for more entities of the plurality of entities, of the first type, or of other types.

It is appreciated that some entities are more complex for migration, for example records that are not default system records but rather created by a system administrator by selecting a default record, editing it, and saving it as a new record. However, once a new record is created, there is no indication of which original record it was derived from. Therefore, as a preliminary stage, in some embodiments, all records may be scanned in advance on a preliminary stage preceding step 208, and the values for the corresponding fields may be mapped to the applicable values, using for example specific algorithms.

It is appreciated that a table or another data structure associating an identifier of an entity in the source telephony system with an identifier of the corresponding entity in the target telephony system may be maintained.

Following the addition of the new first entity, at step 216 a new second entity may be generated upon the second entity. As for the new second entity, one or more primitive fields may be assigned the same (or cast) values corresponding to the values of the primitive fields in the second entity.

At step 220, the new second entity may be added to the target telephony system. Adding the new second entity to the target telephony system may be subject to the application of a rule.

Steps 216 and 220 may be repeated for more entities of the plurality of entities, of the second type, or of other types.

At step 224, the new first entity may be updated, such that its second field points at the new second entity. The assignment may be made using the table associating identifiers of entities in the source and target telephony systems. The identifier of the second entity may be sought for in the table, and the identifier of the new second entity may be fetched and assigned to the correct field in the new first entity.

Step 224 may be repeated for all entities of the first type, or for all entities that have a field whose value points to other one or more entities.

It is appreciated that at step 204, the plurality of entities may be obtained as one batch. However, in some embodiments, the entities may be obtained in two or more groups. However, updating the new first entity may be performed after the second new entry has been generated and added, which can be assured if new entities have been generated and added for all entities of the second type, or for all entities of all types.

In some exemplary embodiments, the updating may be performed, for example, after new second entities have been generated for all entities of the second type, or for all entities provided by the source telephony system.

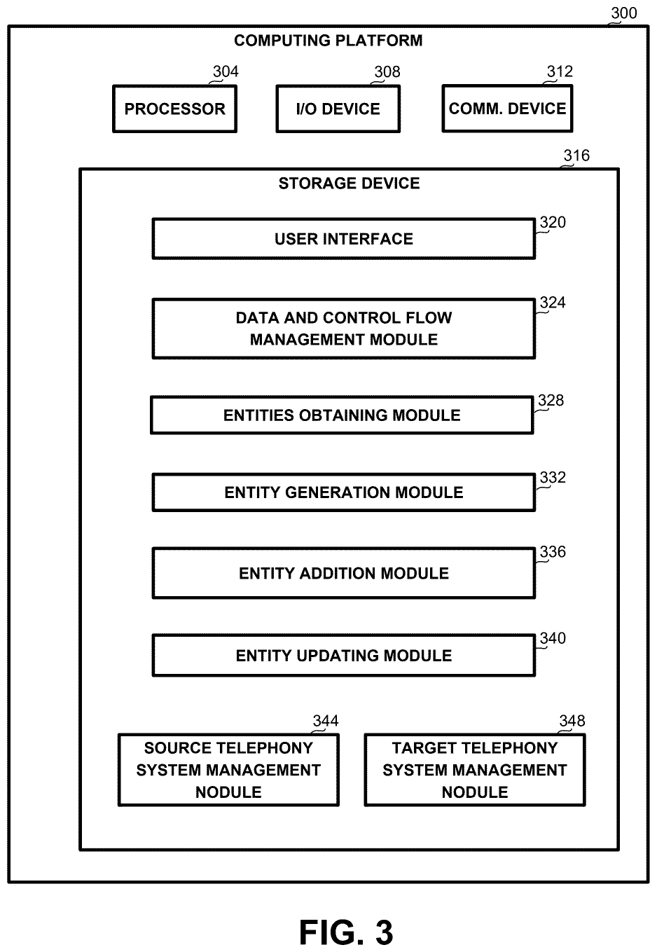

Referring now to FIG. 3, showing a block diagram of a system for migrating entities from a source communication system to a target, in accordance with some exemplary embodiments of the disclosure, in accordance with some exemplary embodiments of the disclosure.

The system may comprise one or more Computing Platforms 300, which may be implemented as a stand-alone system, as part of a system implementing a network telephony system, a computing platform such as a server providing services to one or more clients, or the like.

In some exemplary embodiments of the disclosed subject matter, Computing Platform 300 can comprise Processor 304. Processor 304 may be any one or more processors such as a Central Processing Unit (CPU), a microprocessor, an electronic circuit, an Integrated Circuit (IC) or the like. Processor 304 may be utilized to perform computations required by the apparatus or any of its subcomponents.

In some exemplary embodiments of the disclosed subject matter, Computing Platform 300 can comprise an Input/Output (I/O) Device 308 such as a display, a pointing device, a keyboard, a touch screen, or the like. I/O Device 308 can be utilized to receive input from a user, such as the identify of the source or target telephony systems, entities to be transferred, settings to be employed, and to provide output to a user, such as showing the transferred entities, or the like.

In some exemplary embodiments of the disclosed subject matter, Computing Platform 300 can comprise a Communication Device 312, for communicating with other computing platforms such as one or more telephony systems, for obtaining configurations, or the like.

Computing Platform 300 may comprise a Storage Device 316. Storage Device 316 may be a hard disk drive, a Flash disk, a Random Access Memory (RAM), a memory chip, or the like. In some exemplary embodiments, Storage Device 316 can retain program code operative to cause Processor 304 to perform acts associated with any of the subcomponents of Computing Platform 300 or to perform steps of the flowchart shown in FIG. 2 above. In some exemplary embodiments, Storage Device 316 can be distributed over two or more physical storage devices, whether collocated or distant from each other, wherein each storage device may have access to required information stored in another storage device. One or more of storage devices 316 may be cloud based.

Storage Device 316 can store the modules detailed below. The modules may be arranged as one or more executable files, dynamic libraries, static libraries, methods, functions, services, or the like, programmed in any programming language and under any computing environment.

Storage Device 316 may be configured to retain or be in communication with Source Telephony System Management Module 344 and Target Telephony System Management Module 348, which may be implemented as Application Program Interfaces (APIs) of the corresponding source and target telephony systems, or another mechanism enabling to get or set information in the internal databases of the respective telephony system.

Storage Device 316 may be configured to retain User Interface 320 for displaying to a user such as a migration coordinator, or receiving from the user various aspects associated with the disclosure, such as displaying the number or percentage of transferred entities, the number of entities yet to be transferred, updating about restored interrelations between entities, or the like.

Storage Device 316 may be configured to retain Data and Control Flow Management Module 324, for managing the control and data flow within the apparatus, such that modules are invoked at the correct order and with the required information. For example, Data and Control Flow Management Module 324 can be configured to make sure all entities of each type are transferred, that updating the interrelations between entities starts after all relevant entities have been transferred, to provide output to the coordinator and receive instructions via User Interface 320, or the like.

Storage Device 316 may be configured to retain Entities Obtaining Module 328, for obtaining a list of one or more entities registered with one or more telephony systems, for example source telephony system 116 or target telephony system 124, through Source Telephony System Management Module 344 or Target Telephony System Management Module 348.

Storage Device 316 may be configured to retain Entity Generation Module 332, for generating a new entity to be registered with the target telephony system upon an entity existing in the source telephony system. The generation may include setting values of the primitive fields in the newly created entity in accordance with the values of the corresponding fields in the source entity. Generation may also include updating a table or another data structure for matching an entity in the source telephony system with the corresponding entity in the target telephony system.

Storage Device 316 may be configured to retain Entity Addition Module 336 for adding a newly created entity to the target telephony system.

Storage Device 316 may be configured to retain Entity Updating Module 340 for updating one or more fields of one or more entities in the target telephony system with pointers, identifiers or other characteristics of one or more other newly created entities in the target telephony system.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for migrating a plurality of entities from a source telephony system to a target telephony system, the method comprising:
obtaining from the source telephony system the plurality of entities, the plurality of entities comprises a first entity and a second entity, wherein the first entity comprises at least a first field and a second field, wherein the first field of the first entity has a primitive value, wherein the second field of the first entity has a reference value referring to the second entity;
prior to the second entity being added to the target telephony system:
generating a new first entity corresponding to the first entity, wherein the new first entity comprising a first new field and a second new field, the first new field and the second new field correspond to the first field and the second field in the first entity, respectively, wherein the new first field is assigned the primitive value, wherein the new second field is not assigned a valid reference value; and
adding the new first entity to the target telephony system;
after the new first entity was added to the target telephony system:
generating a new second entity corresponding to the second entity;
adding the new second entity to the target telephony system; and
after the new second entity was added to the target telephony system:
updating the new first entity in the target telephony system, wherein said updating comprises assigning a new reference value referring to the second new entity within the target telephony system to the second new field.

2. The method of claim 1, wherein the first entity is of a first type and the second entity is of a second type, the first and second types are different.

3. The method of claim 2, wherein said updating the new first entity is performed after corresponding entities were added to the target telephony system for each entity of the second type in the plurality of entities.

4. The method of claim 1, wherein said updating the new first entity is performed after corresponding entities were added to the target telephony system for each entity in the plurality of entities.

5. The method of claim 1, wherein said generating the new first entity comprises for each source field in the first entity that has a primitive value and has a corresponding target field in the new first entity, assigning to the corresponding target first a corresponding primitive value.

6. The method of claim 1, wherein said generating the new first entity comprises assigning in the new first entity all primitive values of the first entity.

7. The method of claim 1, wherein the first entity is an entity representing a user, wherein the second entity is an entity representing a telephone device, whereby the first entity refers to the second entity to indicate that the telephone device is used by the user.

8. The method of claim 1, wherein the first entity is a hunt group entity representing a group of phone lines, wherein the second entity represents a phone line, whereby the first entity refers to the second entity to indicate that the phone line is part of the hunt group of phone lines.

9. The method of claim 1, wherein during addition of the first entity to the target telephony system, the first field is assigned a temporary value indicating the second entity.

10. The method of claim 1, wherein the source telephony system is of a different version than the target telephony system.

11. The method of claim 1, wherein adding the new entity or the new second entity to the target telephony system is subject to application of a rule.

12. The method of claim 1, wherein the first entity represents a telephone device and the second entity represents a phone line.

13. The method of claim 1, wherein the plurality of entities comprises:
at least one entity representing a telephone device,
at least one entity representing a phone line, and
at least one entity representing a user.

14. A computerized apparatus having a processor, for migrating a plurality of entities from a source telephony system to a target telephony system, the processor being configured to perform:
obtaining from the source telephony system the plurality of entities, the plurality of entities comprises a first entity and a second entity, wherein the first entity comprises at least a first field and a second field, wherein the first field of the first entity has a primitive value, wherein the second field of the first entity has a reference value referring to the second entity;
prior to the second entity being added to the target telephony system:
generating a new first entity corresponding to the first entity, wherein the new first entity comprising a first new field and a second new field, the first new field and the second new field correspond to the first field and the second field in the first entity, respectively, wherein the new first field is assigned the primitive value, wherein the new second field is not assigned a valid reference value; and
adding the new first entity to the target telephony system;
after the new first entity was added to the target telephony system:
generating a new second entity corresponding to the second entity;
adding the new second entity to the target telephony system; and
after the new second entity was added to the target telephony system:
updating the new first entity in the target telephony system, wherein said updating comprises assigning a new reference value referring to the second new entity within the target telephony system to the second new field.

15. The apparatus of claim 14, wherein the first entity is of a first type and the second entity is of a second type, the first and second types are different, and wherein said updating the new first entity is performed after corresponding entities were added to the target telephony system for each entity of the second type in the plurality of entities.

16. The apparatus of claim 14, wherein said updating the new first entity is performed after corresponding entities were added to the target telephony system for each entity in the plurality of entities.

17. The apparatus of claim 14, wherein said generating the new first entity comprises for each source field in the first entity that has a primitive value and has a corresponding target field in the new first entity, assigning to the corresponding target first a corresponding primitive value.

18. The apparatus of claim 14, wherein said generating the new first entity comprises assigning in the new first entity all primitive values of the first entity.

19. The apparatus of claim 14, wherein the first entity is an entity representing a user, wherein the second entity is an entity representing a telephone device, whereby the first entity refers to the second entity to indicate that the telephone device is used by the user.

20. A computer program product comprising a non-transitory computer readable storage medium retaining program instructions, which program instructions when read by a processor, cause the processor to execute the instructions comprising:
obtaining from the source telephony system the plurality of entities, the plurality of entities comprises a first entity and a second entity, wherein the first entity comprises at least a first field and a second field, wherein the first field of the first entity has a primitive value, wherein the second field of the first entity has a reference value referring to the second entity;
prior to the second entity being added to the target telephony system:
generating a new first entity corresponding to the first entity, wherein the new first entity comprising a first new field and a second new field, the first new field and the second new field correspond to the first field and the second field in the first entity, respectively, wherein the new first field is assigned the primitive value, wherein the new second field is not assigned a valid reference value; and
adding the new first entity to the target telephony system;
after the new first entity was added to the target telephony system:
generating a new second entity corresponding to the second entity;
adding the new second entity to the target telephony system; and
after the new second entity was added to the target telephony system:
updating the new first entity in the target telephony system, wherein said updating comprises assigning a new reference value referring to the second new entity within the target telephony system to the second new field.
